(19) United States
(12) Patent Application Publication
(10) Pub. No.: US 2016/0364909 A1
(43) Pub. Date: Dec. 15, 2016

(54) ARCHITECTURE IMPACT ANALYSIS

(71) Applicant: Microsoft Technology Licensing, LLC., Redmond, WA (US)

(72) Inventors: Patricia Louise Cuplin, Brier, WA (US); Paul Gerard Zangaglia, Sammamish, WA (US); Steven LeRoy Phinney, Seattle, WA (US); Bohua Yu, Bellevue, WA (US); David E. Marsh, Issaquah, WA (US)

(21) Appl. No.: 14/739,926

(22) Filed: Jun. 15, 2015

(51) Int. Cl. G06T 19/00; G06T 17/05

(52) U.S. Cl. CPC G06T 19/003; G06T 17/05

(57) ABSTRACT

A set of processes in a computing system is defined at a plurality of different levels of granularity. For each level, entities that participate at the level are mapped to that level and a data model for the participating entities is generated. An interactive architecture reference model is generated and an interface to the model is exposed for generating an impact analysis based on a capabilities change request.

### BACKGROUND

Computing systems are currently in wide use. Some computing systems are enterprise systems that are deployed by organizations in order to assist in performing tasks that the organization normally performs.

Many enterprise systems are relatively large and complicated systems that provide numerous capabilities and wide varieties of functionality. For example, some enterprise systems (such as enterprise resource planning systems or customer relations management systems, among others) may have thousands of different forms, each having hundreds of different controls and control states. Thus, when someone wishes to make a change to the capabilities or functionality of the system, it can be difficult to identify the impact that the change will have on the system, as a whole.

In addition, many such systems are originally manufactured by a computing system manufacturer. They can then be modified or customized at numerous different levels (such as at the value added reseller level, the independent software vendor level, etc.) before they are eventually deployed at an end user organization. The end user organization may also, itself, perform multiple different customizations on the system before it is finally deployed. This can exacerbate the problems associated with identifying the impact of a desired functionality or capability change on the end user's system.

To further exacerbate the difficulties, many such systems perform a variety of different processes, and each process may have sub-processes or individual activities or tasks within it. In addition, those processes, sub-processes, tasks, etc. may be dependent on (or supported by) a wide variety of different data elements. The data elements, themselves, can be associated with one another, with the various processes, sub-processes, activities, etc., in a wide variety of different ways. This can make it difficult to even provide a consistent or standardized methodology for scoping or articulating the new or modified computing system end state, when a capability or functionality modification is requested.

This not only raises difficulties for the end user organization of the computing systems, but it also raises difficulties for organizations that may attempt to implement the functionality or capability change. Because the impact on the computing system, as a result of the functionality or capability change request, is difficult to identify, it can also be difficult to identify the resources that will be needed in order to implement such a change.

The discussion above is merely provided for general background information and is not intended to be used as an aid in determining the scope of the claimed subject matter.

### SUMMARY

A set of processes in a computing system is defined at a plurality of different levels of granularity. For each level, entities that participate at the level are mapped to that level and a data model for the participating entities is generated. An interactive architecture reference model is generated and an interface to the model is exposed for generating an impact analysis based on a capabilities change request.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1A and 1B (collectively referred to as FIG. 1) show a block diagram of one example of a computing system architecture.

FIG. 2 is a block diagram of one example of a process model.

FIG. 3 is a block diagram of one example of a reference model generator system.

FIG. 4 is a flow diagram of one example of the operation of the architecture shown in FIG. 1 in generating a reference model.

FIGS. 5A and 5B (collectively referred to herein as FIG. 5) show a flow diagram illustrating one example of the overall operation of the architecture shown in FIG. 1 in generating the architecture reference model, in more detail.

FIG. 6 is a block diagram of one example of a model explorer.

FIG. 7 is a flow diagram illustrating one example of the operation of the architecture shown in FIG. 1 in using the architecture reference model to perform an impact analysis.

FIG. 7A is a block diagram of one example of a user interface display.

FIGS. 8A-1 to 8E-2 show examples of user interface displays.

FIG. 9 is a block diagram of one example of the architecture shown in FIG. 1, deployed in a cloud computing architecture.

FIGS. 10-12 show examples of mobile devices that can be used in the architectures shown in the previous figures.

FIG. 13 is a block diagram of one example of a computing environment that can be used in the architectures shown in the previous figures.

### DETAILED DESCRIPTION

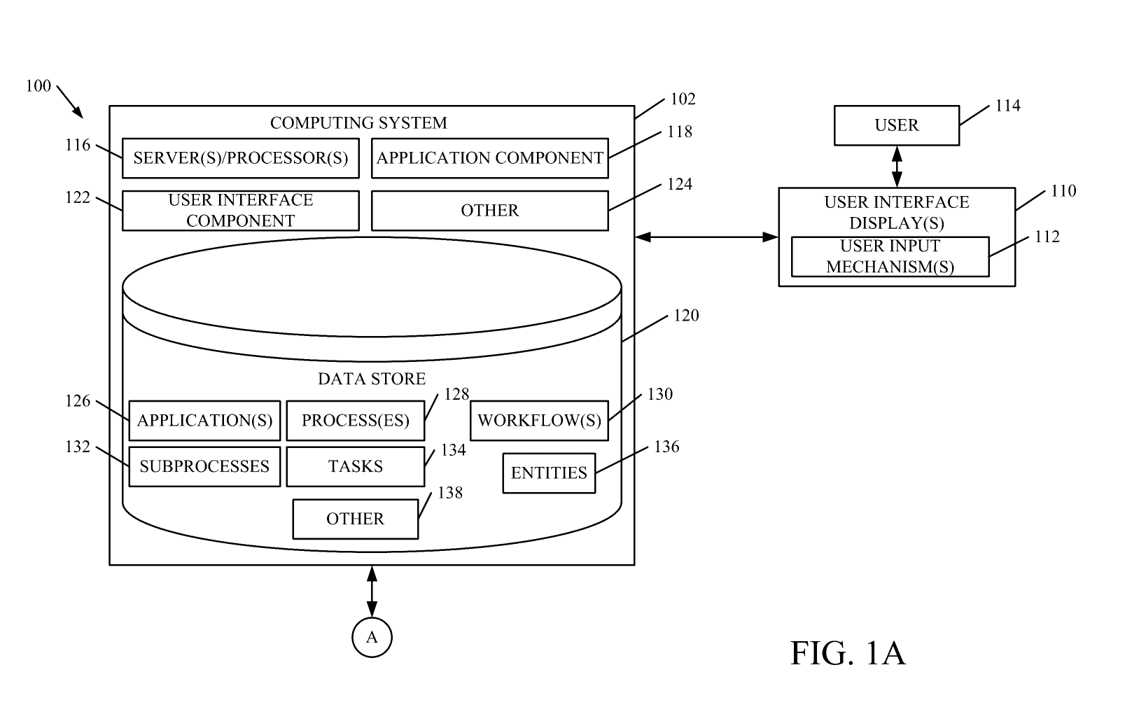

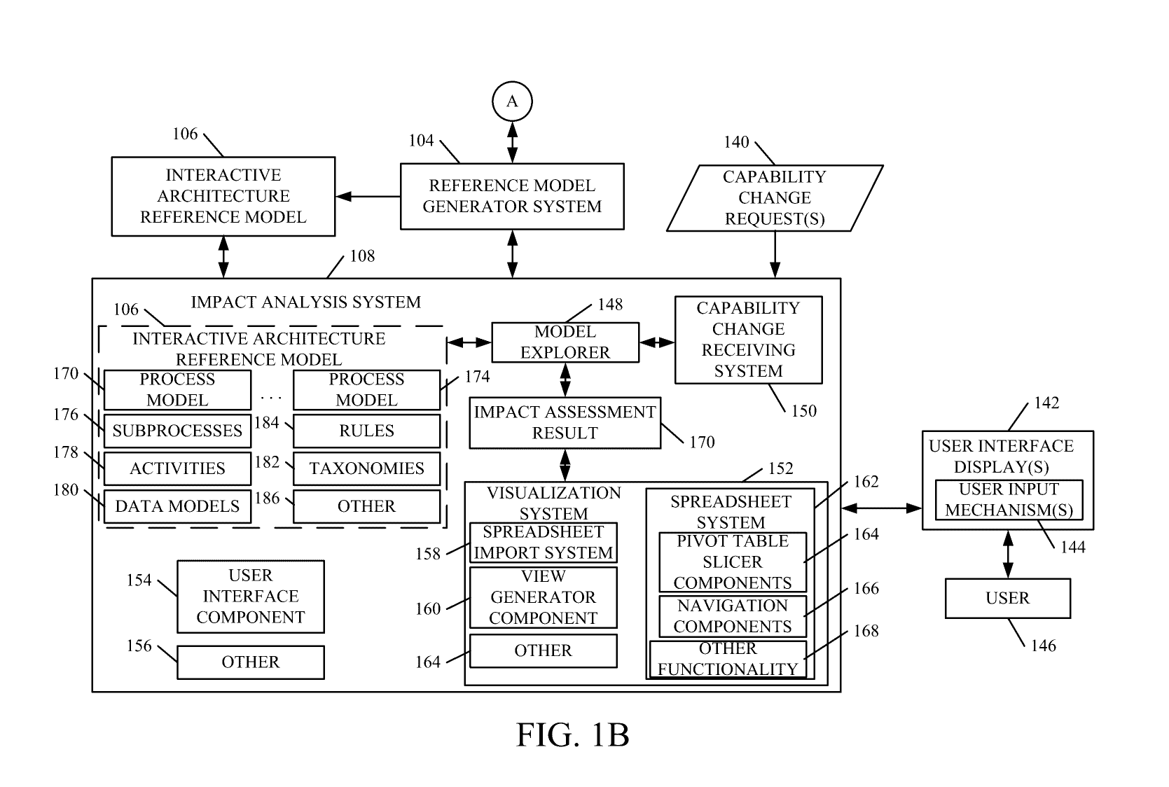

FIGS. 1A and 1B (collectively referred to herein as FIG. 1) show a block diagram of one example of a computing system architecture 100. Architecture 100 illustratively includes computing system 102, reference model generator system 104 that generates an architecture reference model 106, and impact analysis system 108. FIG. 1 also shows that, in one example, computing system 102 generates user interface displays 110, with user input mechanisms 112, for interaction by user 114. User 114 illustratively interacts with user input mechanisms 112 in order to control and manipulate computing system 102. In one example, reference model generator system 104 and impact analysis system 108 can be part of computing system 102. They can also be separate from computing system 102. They are shown separately in FIG. 1 for the sake of example only.

Computing system 102 may, itself, illustratively be an enterprise system. It can be a wide variety of different types of systems, such as a document management system, an electronic mail or other messaging system, an enterprise resource planning (ERP) system, a customer relations management (CRM) system, or a wide variety of other enterprise systems. It can include, for instance, servers or processors 116, application component 118, data store 120, user interface component 122, and a wide variety of other items 124. Data store 120 can include applications 126, processes 128, workflows 130, sub-processes 132, tasks or activities 134, entities 136 and a wide variety of other items 138. Application component 118 illustratively runs applications 126 which perform processes 128 or workflows 130 which, themselves, can include tasks or activities 134. It can also run a wide variety of other sub-processes 132. In doing so, the application illustratively operates on entities 136. Entities 136 illustratively represent items that are identified within computing system 102. For instance, an electronic mail entity defines and represents an electronic mail message. A vendor entity describes and defines a vendor. A customer entity describes and defines a customer. A quote entity defines and describes a quote. An invoice entity describes and defines an invoice. It will be appreciated that this is only a small set of the different things that can be represented by entities 136.

Reference model generator system 104 illustratively accesses computing system 102 and generates interactive architecture reference model 106 that represents the architecture (e.g., the processes, sub-processes, workflows, tasks or activities, entities, etc.) in computing system 102. It will be noted that reference model generator system 104 can be a part of computing system 102, or separate from computing system 102. Also, architecture reference model 106 can be stored and accessible in a location separate from impact analysis system 108, or within impact analysis system 108.

In any case, impact analysis system 108 illustratively receives capability change requests 140 and accesses architecture reference model 106, which is an interactive model. Architecture reference model 106 illustratively identifies an impact that a given capability change request 140 will have on the computing system architecture of computing system 102. System 108 thus illustratively generates user interface displays 142 with user input mechanisms 144 for interaction by user 146. User 146 illustratively interacts with user input mechanisms 144 in order to generate a visualization of an impact assessment that identifies the impact on the architecture of computing system 102 based on a capability change request 140. User 146 can illustratively drill up or down within the impact assessment to identify various pieces of the architecture of computing system 102 that will be impacted, and it can also illustratively navigate through the architecture reference model 106. These interactions are described in greater detail below.

Impact analysis system 108 illustratively includes model explorer 148, capability change receiving system 150, visualization system 152, user interface component 154, and it can include architecture reference model 106, and other items 156. Visualization system 152 illustratively includes spreadsheet import system 158, view generator component 160, spreadsheet system 162, and it can include other items 164. Spreadsheet system 162 can be a spreadsheet application which includes pivot table slicer components 164, navigation components 166, and other functionality 168. The components and functionality within spreadsheet system 162 illustratively allow a user to perform spreadsheet functionality on displayed data.

Model explorer 148 illustratively accesses interactive architecture reference model 106 based upon a capability change request 140 received by capability change receiving system 150. It generates an impact assessment result 170 that represents an impact on the architecture of computing system 102, based on the capability change request 140. This can be imported into spreadsheet system 162 by spreadsheet import system 158 in visualization system 152. View generator component 160 then generates a visualization of the impact assessment result 170 and controls user interface component 154 to display that visualization for user 146. It can be displayed along with a variety of different user input mechanisms that can be actuated by user 146 in order to perform actions on the visualization of the impact assessment result 170. For instance, the user can drill up or down within the impact assessment. The user can also navigate the architecture reference model or interact with the model 106 in a wide variety of other ways.

FIG. 1 also shows that, in one example, interactive architecture reference model 106 can include a plurality of different process models 172-174. Each process model illustratively represents a process 128 within computing system 102. The interactive architecture reference model 106 can also include one or more sub-processes 176, a set of tasks or activities 178, data models 180, taxonomies 182, rules 184, and it can include other items 186. The process models 172-174 illustratively identify the various entities or data models 180 that support the corresponding process represented by the corresponding process model. The process models 172-174 also illustratively identify sub-processes 176, activities or tasks 178, taxonomies 182 and rules 184 corresponding to each of the items that make up the process represented by the corresponding process model. Each process model 172-174 thus identifies a process, and the sub-processes 176 and activities 178 that make up that process. It maps the process itself, the sub-processes 176 and activities 178 to data models 180 that support each of those items, and also to the taxonomies 182 that describe the data models and other items in the process, sub-processes and activities. It can also map to rules 184 that trigger execution of the process, the sub-processes 176 and the activities 178.

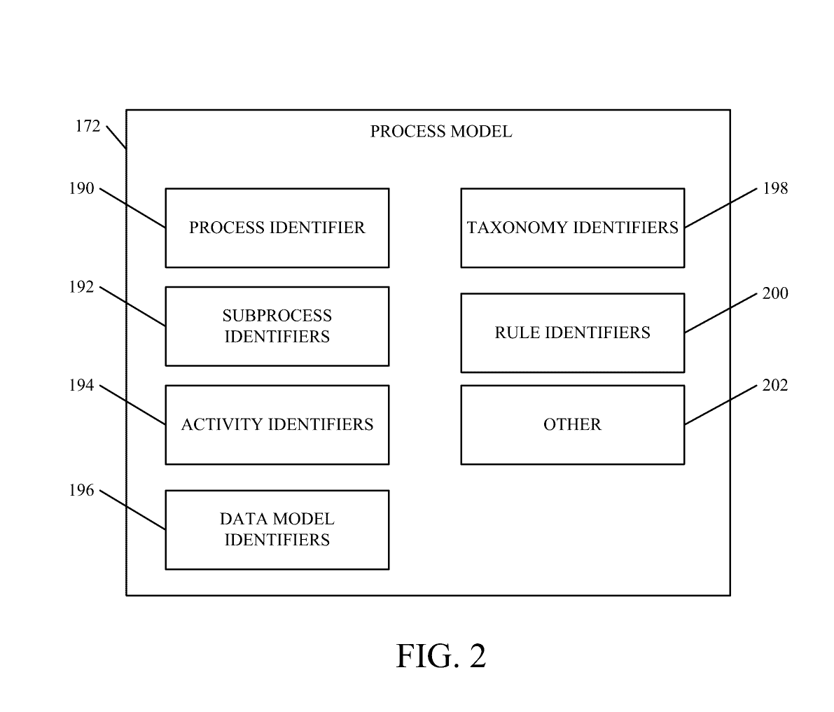

FIG. 2 shows a block diagram of one example of a process model (for the sake of the present example it is process model 172) in more detail. Process model 172 illustratively includes a process identifier 190 that identifies the particular process 128 in computing system 102 modeled by process model 172. It also illustratively includes a set of sub-process identifiers 192 that identify the various sub-processes that make up the process that model 172 represents. It can include a set of activity or task identifiers 194 that identify the activities or tasks within each sub-process 192. It also illustratively includes a set of data model identifiers 196 that identify data models 180 that model the entities or other data items that support the process, the sub-processes, and the activities or tasks identified by identifiers 190, 192, and 194, respectively.

Process model 172 can also include a set of taxonomy identifiers 198, rule identifiers 200, and other items 202. The taxonomy identifiers 198 identify taxonomies 182 that define the various data items or other items associated with the process modeled by process model 172. Rule identifiers 200 illustratively identify rules within computing system 102 that cause the process and the various sub-processes, activities or tasks and other items that make up the process represented by model 172, to be executed. Thus, it can be seen that process model 172 illustratively maps the process identified by process identifier 190 to the various sub-processes and activities or tasks represented by identifiers 192 and 194. It also maps the process and each of the sub-processes and tasks or activities to data models that support them, through data model identifiers 196. Further, it maps the process, sub-processes and activities to taxonomies and rules, using taxonomy identifiers 198 and rule identifiers 200.

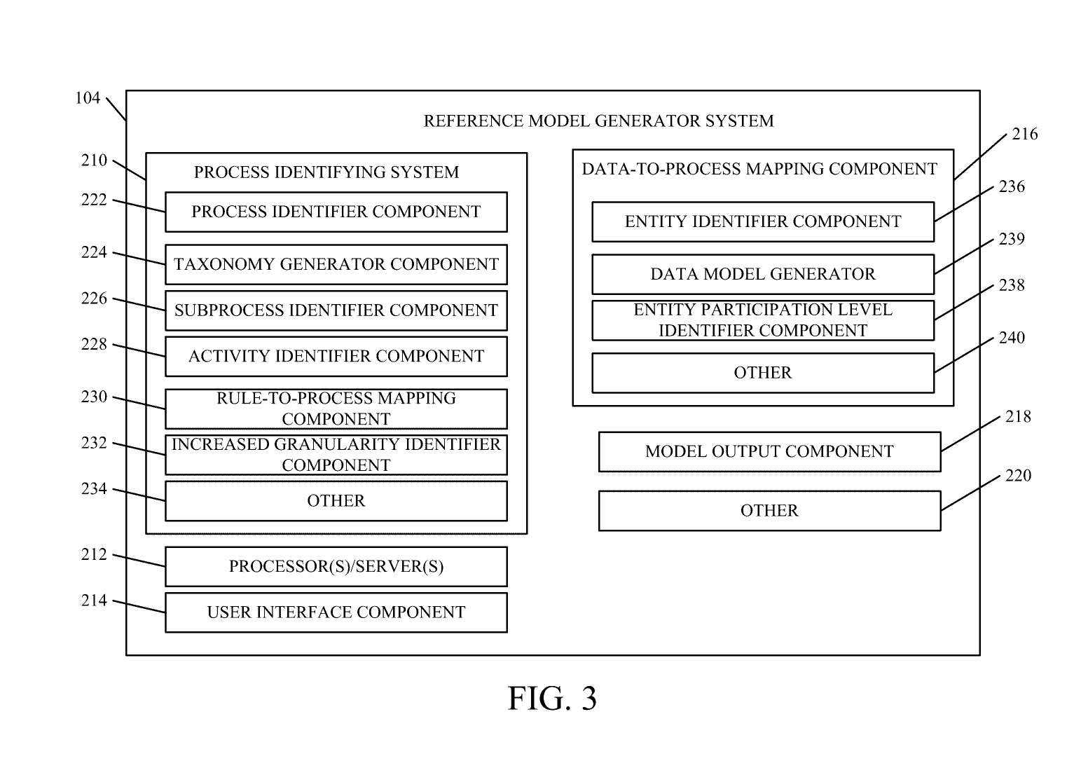

FIG. 3 is a block diagram of one example of reference model generator system 104, in more detail. FIG. 3 shows that, in one example, system 104 illustratively includes process identifying system 210, a set of processors or servers 212, user interface component 214, data-to-process mapping component 216, model output component 218, and it can include other items 220.

Process identifying system 210 illustratively includes process identifier component 222, taxonomy generator component 224, sub-process identifier component 226, activity identifier component 228, rule-to-process mapping component 230, increased granularity identifier component 232, and it can include other items 234. The various components in process identifying system 210 illustratively identify each process in computing system 102 at a variety of different levels of granularity. The levels of granularity can include the process itself, sub-processes that make up that process, and activities or tasks in the process or each of the sub-processes. It can include higher levels of granularity as well. Process identifying system 210, through rule-to-process mapping component 230, also identifies the various rules 184 that cause the processes, sub-processes and activities to be performed. It maps those rules to the individual processes, sub-processes, and activities that they trigger. Taxonomy generator component 224 illustratively identifies taxonomies that define the various data entities or other items within the processes, sub-processes, and activities. It also can generate user interface displays with user input mechanisms, which can be actuated to allow user 146 (or another user) to generate or modify taxonomies as well.

Data-to-process mapping component 216 illustratively includes entity identifier component 236, entity participation level identifier component 238, data model generator 239 and it can include other items 240. Entity identifier component 236 identifies the various data entities that support the processes, sub-processes and activities identified by system 210, and maps those entities to the processes, sub-processes and activities. Entity participation level identifier component 238 illustratively identifies the participation level of each of the identified entities in the process, sub-process, activity, etc. For instance, the entity may participate in a read only way, in a way where it can be modified, or in a way where it is created. Data model generator 239 then generates a data model representing the identified entities, and their participation level, for each of the processes, sub-processes, and activities identified by system 210. Component 216 maps the processes, sub-processes and activities to these corresponding data models as well.

Model output component 218 illustratively outputs the interactive architecture reference model 106, with an interface, that makes it accessible by impact analysis system 108. This is described in greater detail below.

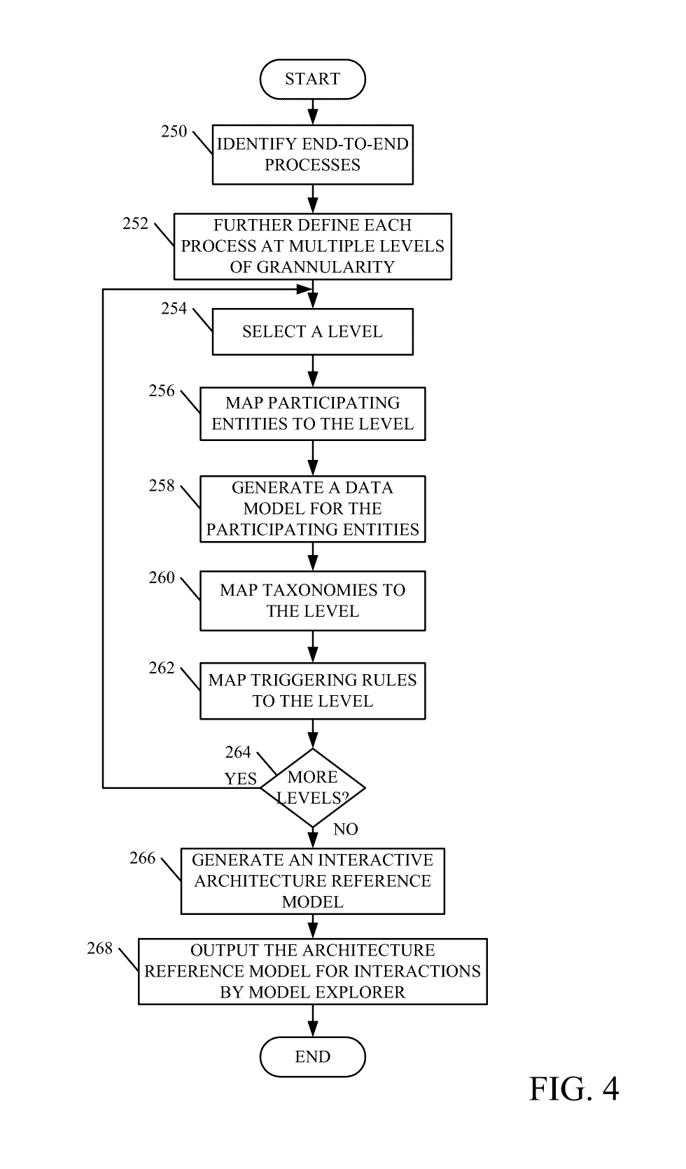

FIG. 4 is a flow diagram illustrating one example of the overall operation of reference model generator system 104, in generating interactive architecture reference model 106. Process identifier component 222 first identifies one or more end-to-end processes within computing system 102. This is indicated by block 250 in FIG. 4. The particular end-to-end processes performed by computing system 102 will vary widely, depending on the nature of computing system 102. For instance, where it is an enterprise resource planning system, the end-to-end processes may represent a first set of functions, whereas if computing system 102 is a document management system, the processes may represent a second set of functions.

Each of the processes may illustratively include metadata that define the processes and how they relate to one another. Therefore, in one example, process identifier component 222 analyzes the metadata to determine which processes have inputs and outputs relative to other processes, in a process hierarchy. The metadata may define the hierarchy as well. Further, process identifier component 222 may illustratively generate user interface displays with user input mechanisms that can be actuated to allow a user to further define or input the various processes or identify those processes as well. This can be done through impact analysis system 108, or by controlling user interface component 214 to generate user interface displays with the user input mechanisms for another user.

Process identifying system 210 then further defines each of the processes identified at block 250, at multiple different levels of granularity. This is indicated by block 252. For instance, it can define a first level of granularity that identifies sub-processes within each process. A second level of granularity may be activities or tasks performed within each sub-process. Of course, the different levels of granularity can take different forms, depending on the particular processes implemented by computing system 102. Also, again, the sub-processes, activities or tasks, etc., may also be defined by metadata within computing system 102. Therefore, sub-process identifier component 226 and activity identifier component 228 may illustratively analyze the metadata to identify a hierarchical structure of the sub-processes, activities or tasks, etc. It can use the metadata to identify which sub-processes and activities belong to which processes, and how they are hierarchically dependent on one another. In another example, of course, user interface displays with user input mechanisms can be generated by components 226 and 228 to allow a user to further define the sub-processes, activities or tasks, etc.

At some point, data-to-process mapping component 216 selects a level of granularity for processing. This is indicated by block 254. For instance, it may select a process, a sub-process, an activity or task, etc. Data-to-process mapping component 216 then maps the participating entities to the level of granularity that has been selected. As an example, if a sub-process has been selected, then data-to-process mapping component 216 maps the entities that support that sub-process, to the sub-process itself. Mapping the participating entities to the selected level of granularity is indicated by block 256.

Data model generator 239 then generates a data model for the participating entities. This is indicated by block 258. Taxonomy generator component 224 then maps the taxonomies to the level of granularity, as indicated by block 260. Rule-to-process mapping component 230 then identifies the rules that cause the particular level of granularity to be performed (e.g., if the selected level of granularity is a sub-process, then component 230 identifies the rules that trigger that sub-process) and maps those rules to the selected level of granularity. This is indicated by block 262. The entities and the relationships among the entities and the processes, sub-processes, activities, etc. can be defined in metadata. Also, the rules and taxonomies can be defined and related to the processes, sub-processes, activities etc. in metadata. Therefore, data model generator 239 and components 224 and 230 can use the metadata to perform their functions.

Reference model generator system 104 continues to map entities, generate data models, and map taxonomies and triggering rules for each of the levels of granularity that have been defined for the process. This is indicated by block 264. Once the definitions and mappings are complete, then model generator and output component 218 generates the interactive architecture reference model based upon the items generated by system 104, and outputs the architecture reference model for interaction by model explorer 148 in impact analysis system 108. Generating the reference model is indicated by block 266, and outputting it for interaction by model explorer 148 is indicated by block 268.

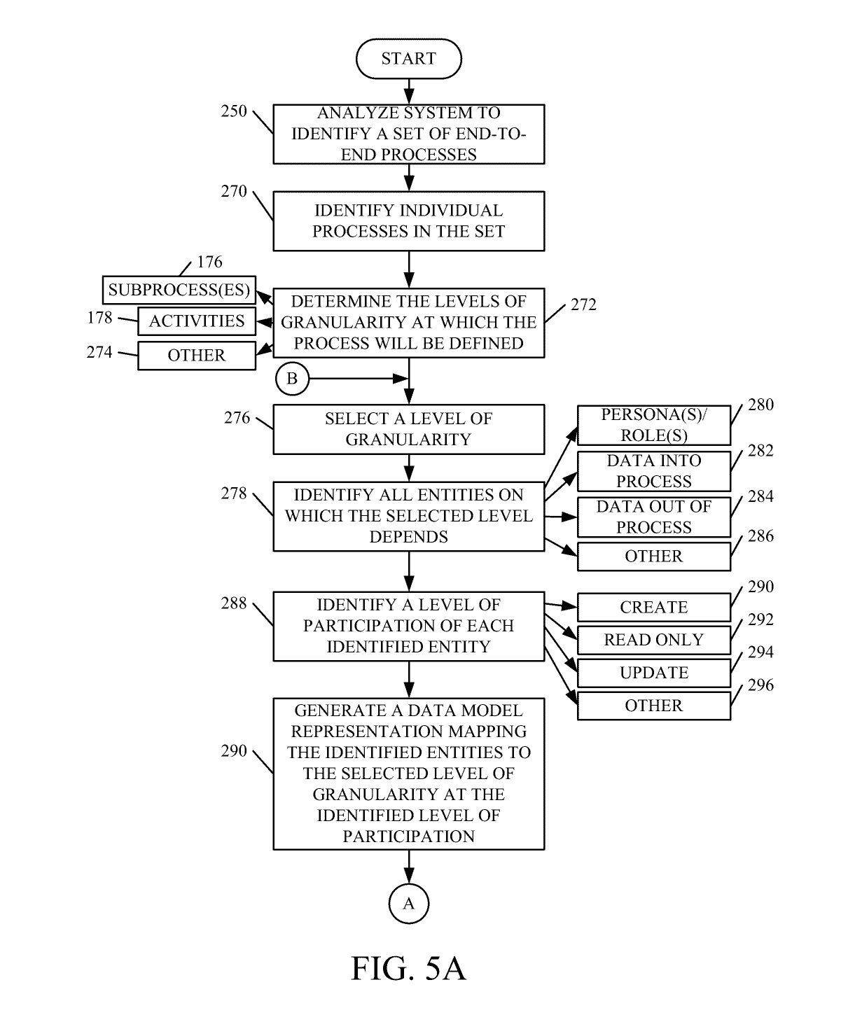

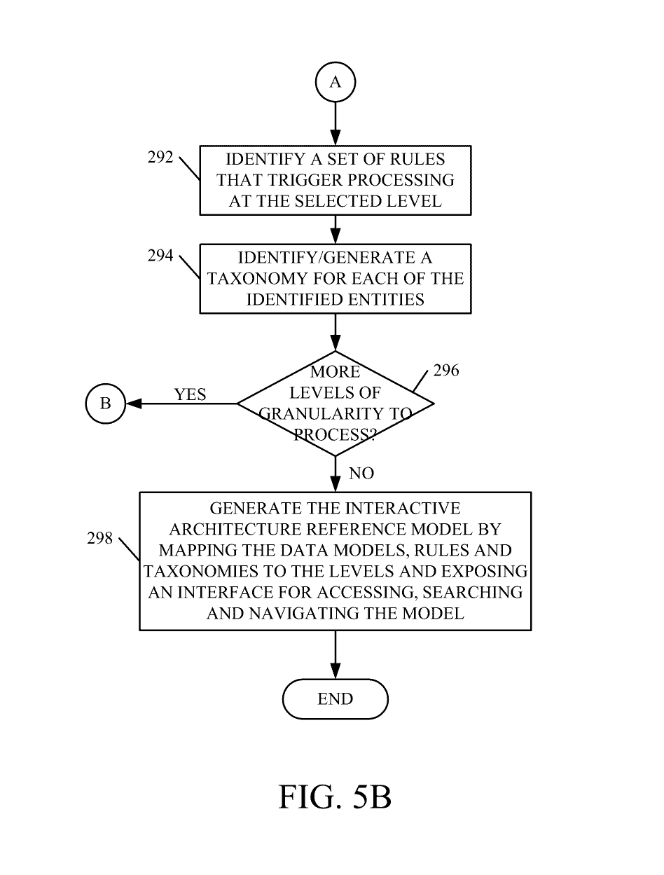

FIGS. 5A and 5B (collectively referred to herein as FIG. 5) show a flow diagram illustrating one example of the operation of reference model generator system 104, in more detail. Process identifier component 222 first analyzes computing system 102 to identify a set of end-to-end processes. This was discussed above with respect to block 250 in FIG. 4. Component 222 then identifies the individual processes within that set of processes. This is indicated by block 270 in FIG. 5. Process identifying system 210 then determines the levels of granularity at which the individual processes will be defined. This is indicated by block 272. For instance, they may be defined at the overall process level 176, at the sub-process level 178, or at other levels of granularity 274.

Process identifying system 210 then selects a level of granularity. This is indicated by block 276. For instance, if the process has been analyzed at the sub-process and activity level, then the process, a sub-process, or an activity can be selected at block 276.

Entity identifier component 236 then identifies all entities on which the selected level of granularity depends. This is indicated by block 278. For instance, if the selected level of granularity is a sub-process, component 236 may identify personas or roles 280 that support that sub-process. These may be people or roles that are allowed to input data to the sub-process, that are somehow related to the sub-process, or that receive data from the sub-process. The entities may include entities that act as, or provide, data into the process, sub-process or activity. This is indicated by block 282. The entities may represent the data that is output from the process, sub-process or activity, as indicated by block 284. Of course, the data that supports the selected level of granularity can represent a wide variety of other data items 286 as well.

Entity participation level identifier component 238 then identifies the level of participation of each identified entity. This can be defined in metadata, or otherwise. This is indicated by block 288. For instance, the entity may participate in the selected process, sub-process or activity at a “create” level. This is indicated by block 290. It may participate at a “read only” level as indicated by block 292 or at an “update” level as indicated by block 294. Of course, it may participate at other levels of participation as well, and this indicated by block 296. The level of participation basically indicates the status of the entity, such as whether it will be created or could be created in the selected process, sub-process or activity, whether it is read only, whether it can be modified or updated, etc.

Once the entities, and their level of participation, are identified, data model generator 239 generates a data model representation and maps the identified entities to the selected level of granularity, at the identified level of participation. This is indicated by block 290. For instance, each entity may be associated with other entities, processes, sub-processes, activities, etc., in a wide variety of different ways. The association may be hierarchical or defined in other ways. The association can be expressed in metadata in computing system 102. Thus, data model generator 239 can access the metadata for the identified entities to generate the data model. In another example, the data model is already generated, and data model generator 239 simply accesses the data model for inclusion in the interactive architecture reference model 106.

Rule-to-process mapping component 230 then identifies a set of rules that trigger processing at the selected level of granularity. For instance, if the selected level of granularity is a sub-process, then component 230 identifies any logic rules or other rules in computing system 102 that trigger that sub-process. Identifying the rules is indicated by block 292 in FIG. 5.

Taxonomy generator component 224 then either generates or identifies a taxonomy for each of the identified entities. It can also do this for the sub-process itself, or for other items related to the sub-process. This is indicated by block 294. If the taxonomy already exists for each of the entities, it is simply extracted for inclusion in the interactive architecture reference model 106. If not, taxonomy generator component 224 can generate it automatically, or expose user input mechanisms that can be actuated by a user in order to create or modify the taxonomy.

Reference model generator system 104 then determines whether there are any additional items at the present level of granularity (e.g., if the selected level of granularity is the sub-process level, it can determine whether there are more sub-processes) to process and if not, whether there are additional levels of granularity to process. This is indicated by block 296. If so, processing reverts to block 276 where the next item at the present level, or the next level of granularity, is selected, entities that support it are identified, their participation level is identified, the corresponding data model is generated, and the triggering rules and taxonomy are also identified. This continues until all items at all levels of granularity have been processed.

When the processing is completed, then model output component 218 generates the interactive architecture reference model 106 by mapping the entities, data models, rules and taxonomies to the levels of granularity that they correspond to, and exposing an interface for accessing, searching and navigating the model, using those mappings. Generating the interactive architecture reference model 106 is indicated by block 298 in FIG. 5.

Model explorer 148 illustratively includes model interaction component 300, dependency identifier component 302, drill component 304, data/process navigation component 306, and it can include other items 308. Model explorer 148 illustratively surfaces input mechanisms that can be actuated by user 146 in order to interact with the interactive architecture reference model 106. For instance, drill component 304 illustratively generates drill user input mechanisms that can be actuated by user 146 in order to drill up or down into less or more detail, respectively, in interactive architecture reference model 106. The user can drill into sub-processes, activities, or deeper levels of granularity. Data/process navigation component 306 also illustratively generates user input mechanisms that can be used by user 146 to navigate through the interactive architecture reference model 106 in other ways. For instance, when viewing a process, the user can illustratively navigate to a data model that supports that process. The user can also illustratively navigate to a set of rules that trigger the process, and a taxonomy that defines elements of the process. Dependency identifier component 302 identifies hierarchical dependencies within the process, and model interaction component 300 interacts with model 106, based upon the user inputs, so that visualization system 152 can surface visualizations for further interaction by user 146.

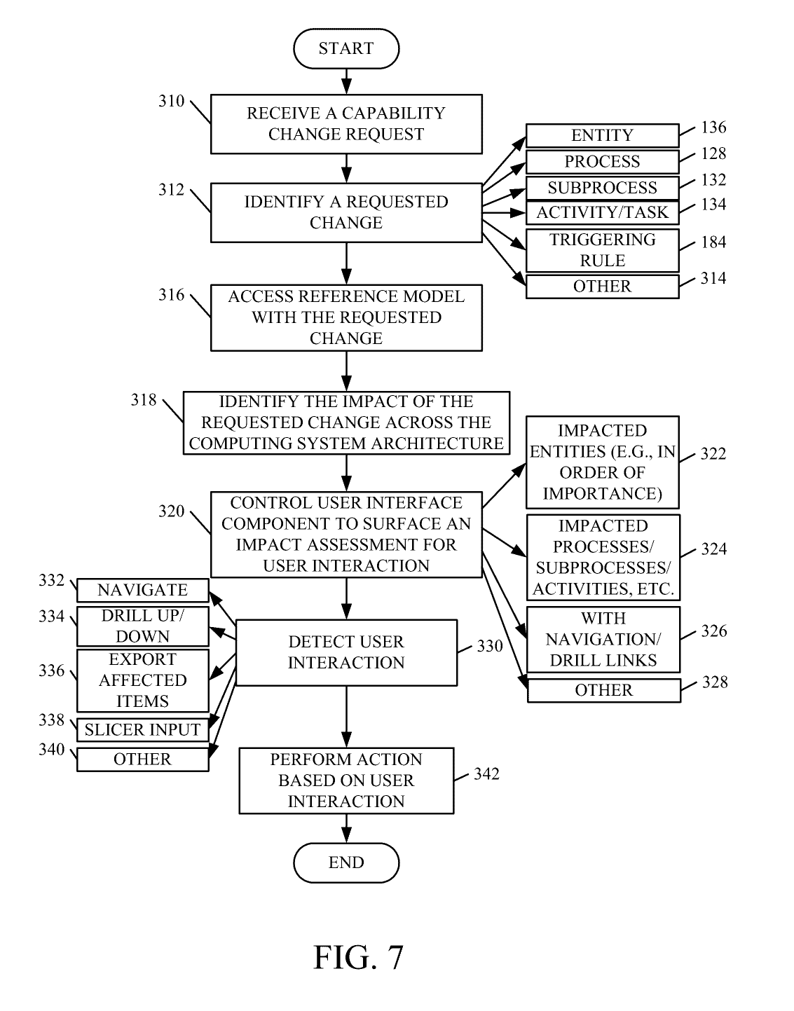

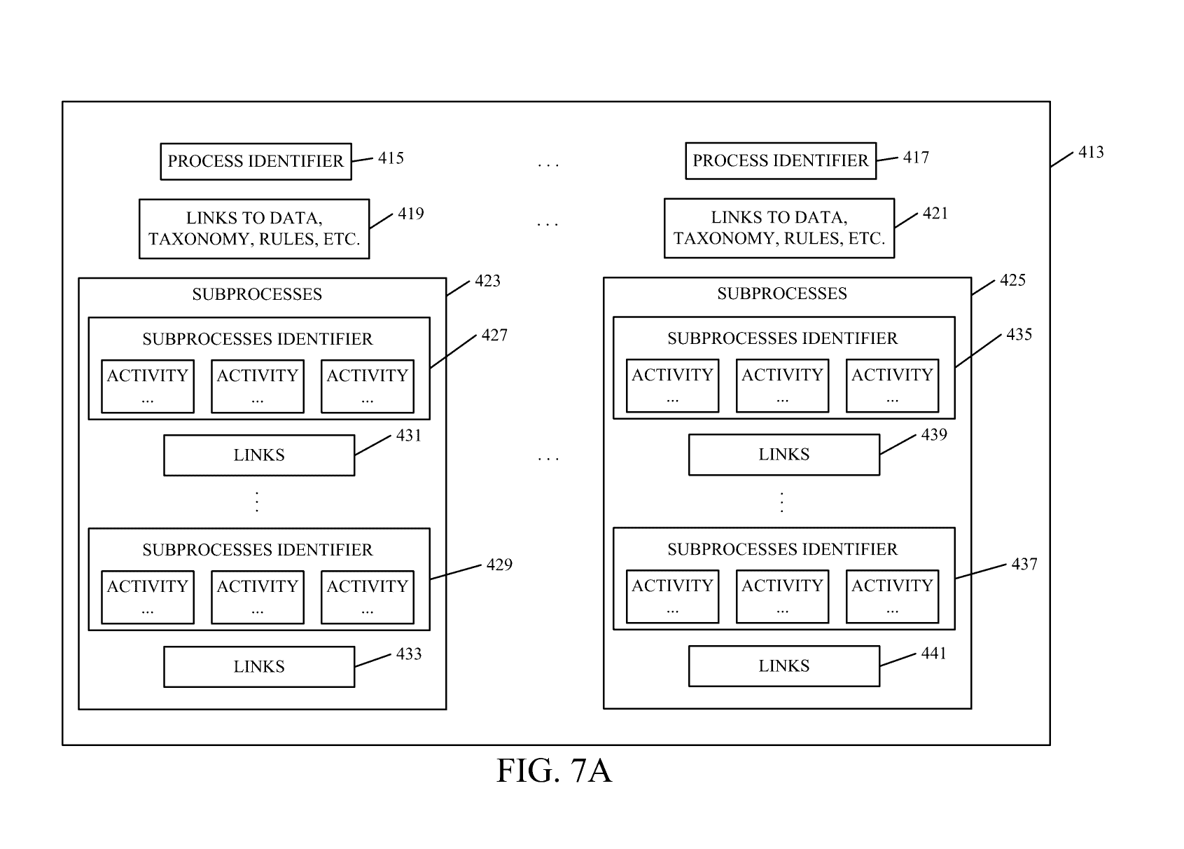

FIG. 7 is a flow diagram illustrating one example of the operation of impact analysis system 108 in receiving a capability change request and generating an impact assessment result 170, using interactive architecture reference model 106. Impact assessment result 170 illustratively identifies an impact of the capability change request 140 on the architecture of computing system 102, as modeled by interactive architecture model 106.

Capability change receiving system 150 first receives a capability change request 140. For instance, a user 114 of computing system 102 may desire to have the capabilities or functionality of system 102 modified in some way. User 114 can provide the capability change request 140 that represents the desired modification, to impact analysis system 108 where it is received by system 150. Receiving the capability change request is indicated by block 310 in FIG. 7.

System 150 then identifies the requested change as indicated by block 312. For instance, the requested change may identify a change to an entity 136, a change to a process 128, a change to a sub-process 132, a change to an activity or task 134, a change to a triggering rule 184, or a change to a wide variety of other things 314.

Model interaction component 130 then accesses reference model 106, with the requested change. This is indicated by block 316. In one example, reference model 106 exposes an interface (such as an application programming interface or another interface) that takes, as an input, the requested change and returns impact assessment result 170. Of course, component 300 can access model 106 in other ways as well.

Interactive architecture reference model 106 then identifies the impact of the requested change across the computing system architecture of computing system 102. This is indicated by block 318. The impact, for instance, may identify the processes, sub-processes, entities, tasks or activities, and a wide variety of other things in the architecture of computing system 102, that will be affected by the requested change.

Model explorer 148 outputs the impact as impact assessment result 170 to visualization system 152. Visualization system 152 illustratively controls user interface component 154 to surface the impact assessment result 170 for interaction by a user. For instance, the visualization can be surfaced as a user interface 142 for interaction by user 146, or it can be surfaced as a user interface display 110 for interaction by user 114. All of these scenarios are contemplated herein. Controlling the interface component to surface the impact assessment 170 for user interaction is indicated by block 320 in FIG. 7.

The visualization of the impact assessment 170 can show impacted entities as indicated by block 322. The entities may be more or less important to the particular process, sub-process, etc. that is being affected. Therefore, the entities can be shown in order of importance, or otherwise. The visualization can also show the impacted processes, sub-processes, activities, etc. This is indicated by block 324. The visualization can include navigation and drill actuator or links, as well as export mechanisms that can be actuated by the user. This is indicated by block 326. The navigation and drill actuators can be actuated to navigate through the interactive architecture reference model 106, starting from the portion of the architecture that is affected, as surfaced in the impact assessment result 170. They can be used also to drill down to further levels of detail or up to more abstract levels. The export mechanisms can be actuated to export the results of the impact analysis for transmission to other organizations who may implement the change, etc. Of course, the visualization can show other items as well, and this is indicated by block 328.

As one example, spreadsheet import system 158 can import the impact assessment results 170 into a spreadsheet system 162, which can provide user input mechanisms that enable the user to perform spreadsheet functionality on the impact results. For instance, pivot table slicer components 164 can provide user input mechanisms that allow the user to slice and dice the results of the impact across various dimensions. Navigation components 166 can allow the user to navigate through the impact assessment, and other functionality 168 can be provided as well.

Visualization system 152 then detects any user interactions with the user input mechanisms on the visualization that was surfaced. This is indicated by block 330. The inputs may include a navigate input 332, a drill up/down input 334, an export input to export the affected items as indicated by block 336, a slicer input 338, or a wide variety of other user interaction inputs 340. Visualization system 152 then controls the various items in impact analysis system 108 to perform action based upon the detected user interaction. This is indicated by block 342.

FIG. 7A is a block diagram of one example of a user interface display 413 that can be generated to allow a user to access the interactive architecture reference model 106. Display 413 illustratively includes a set of user actuatable process identifier display elements 415-417. Elements 415-417 illustratively each represent a process in a set of end-to-end processes in computing system 102. Each element 415-417 can illustratively be actuated to drill into more detail about the corresponding process.

In one example, each process identifier display element 415-417 has a corresponding set of links 419-421. The links 419-421 link to (e.g., connect or provide a pointer to) the data entities (or data model), taxonomy and triggering rules for the corresponding process. A user can actuate the links to be navigated to the item linked to.

In the example shown in FIG. 7A, each process identifier display element 415-417 also has a corresponding sub-process display section 423-425. Display sections 423-425 have display elements corresponding to the sub-processes in each process represented by display elements 415-417. For instance, sub-process display section 423 includes sub-process identifier display elements 427-429, that each represent a sub-process in the process represented by process identifier display element 415. Sub-process display section 425 includes sub-process identifier display elements 435-437, that each represent a sub-process in the process represented by process identifier display element 417. Display elements 427, 429, 435 and 437 are each illustratively user actuatable elements. When the user actuates one of them, the user is illustratively navigated to a more detailed display that shows more details of the corresponding sub-process. For instance, when a user clicks on a subprocess identifier 427-429, the user can be navigated to a more detailed display of the activities related to that subprocess. This can be continued to additional levels of granularity as well. By way of example, an activity may have multiple tasks. A task may have multiple steps, etc.

Each of the sub-process identifier display elements illustratively has a corresponding set of links 431, 433, 439 and 441, respectively. The links illustratively link to the data entities (or data model) supporting the corresponding process, the related taxonomies and the corresponding triggering rules. These are, of course, examples only.

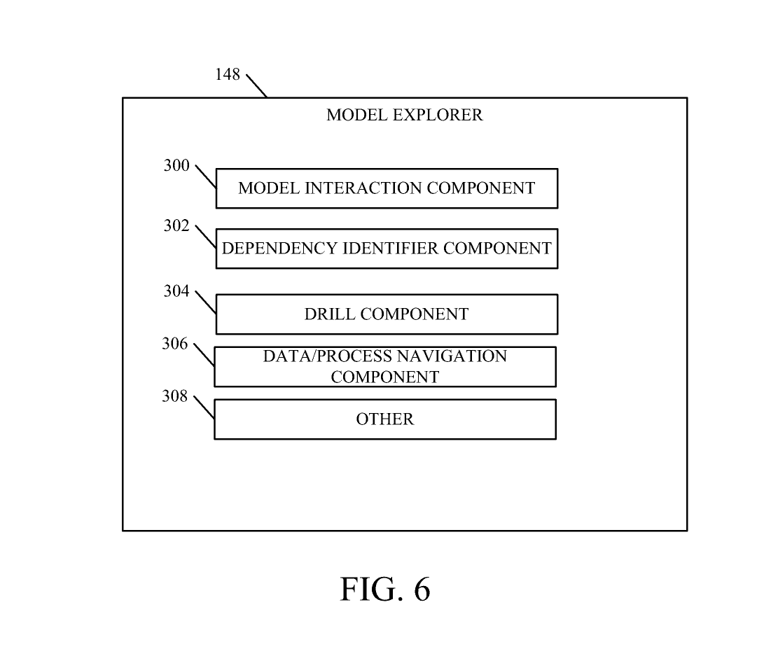

FIGS. 8A-1 to 8E show a variety of different user interface displays that can be generated.

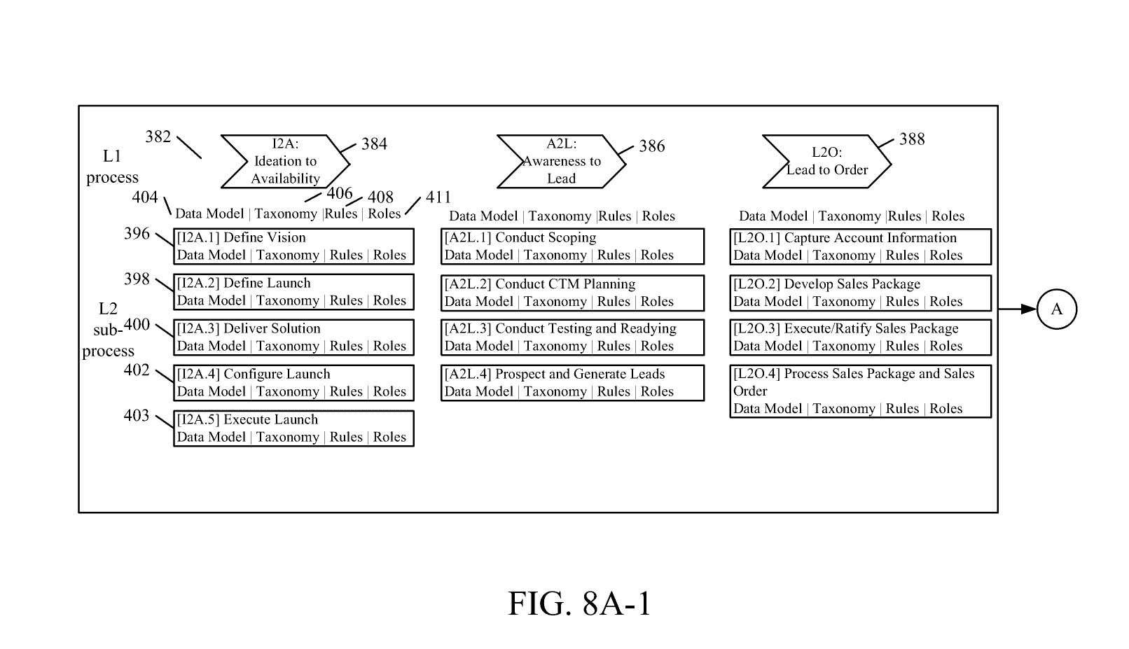

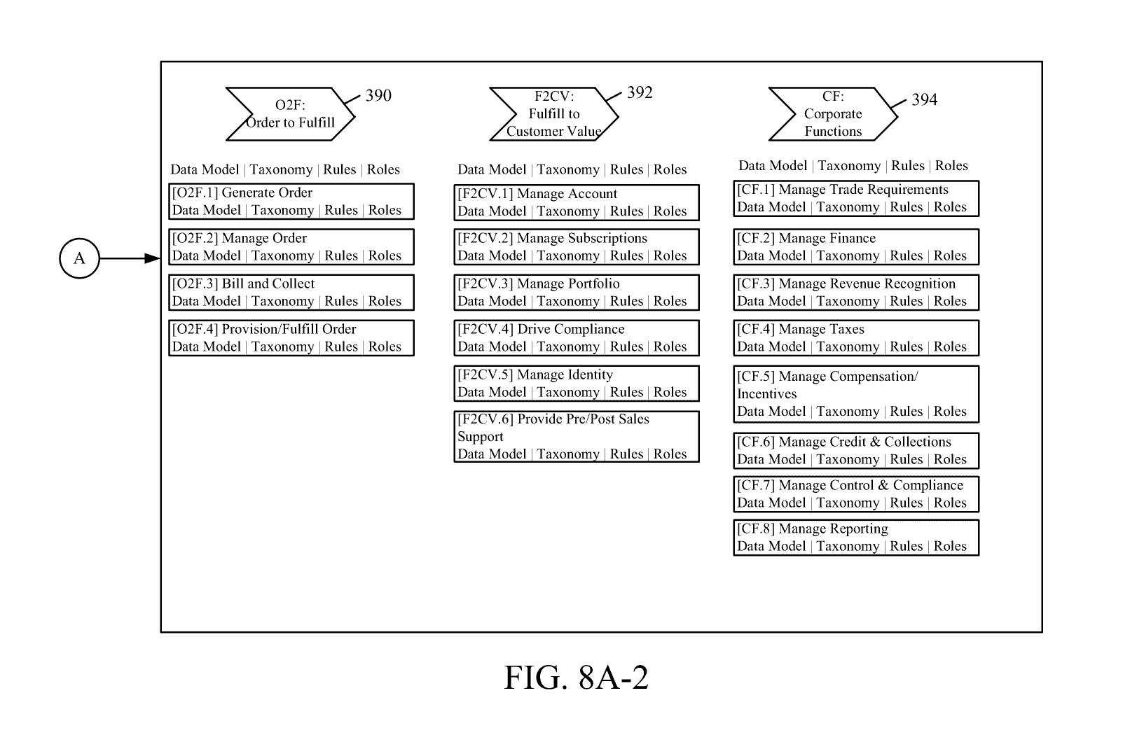

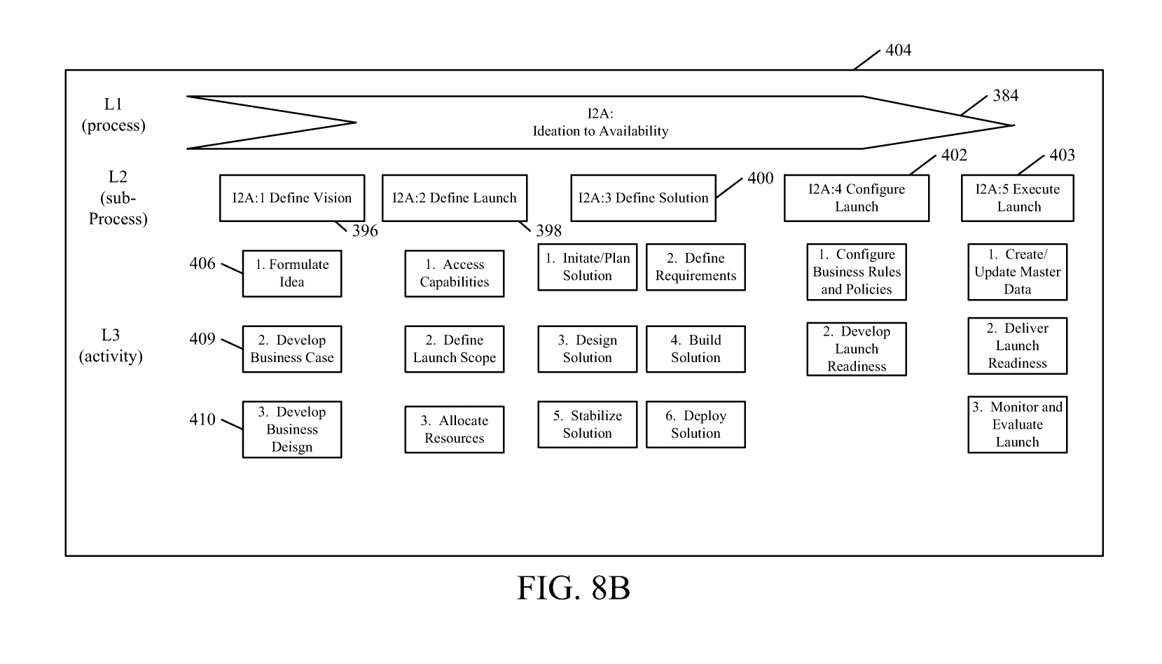

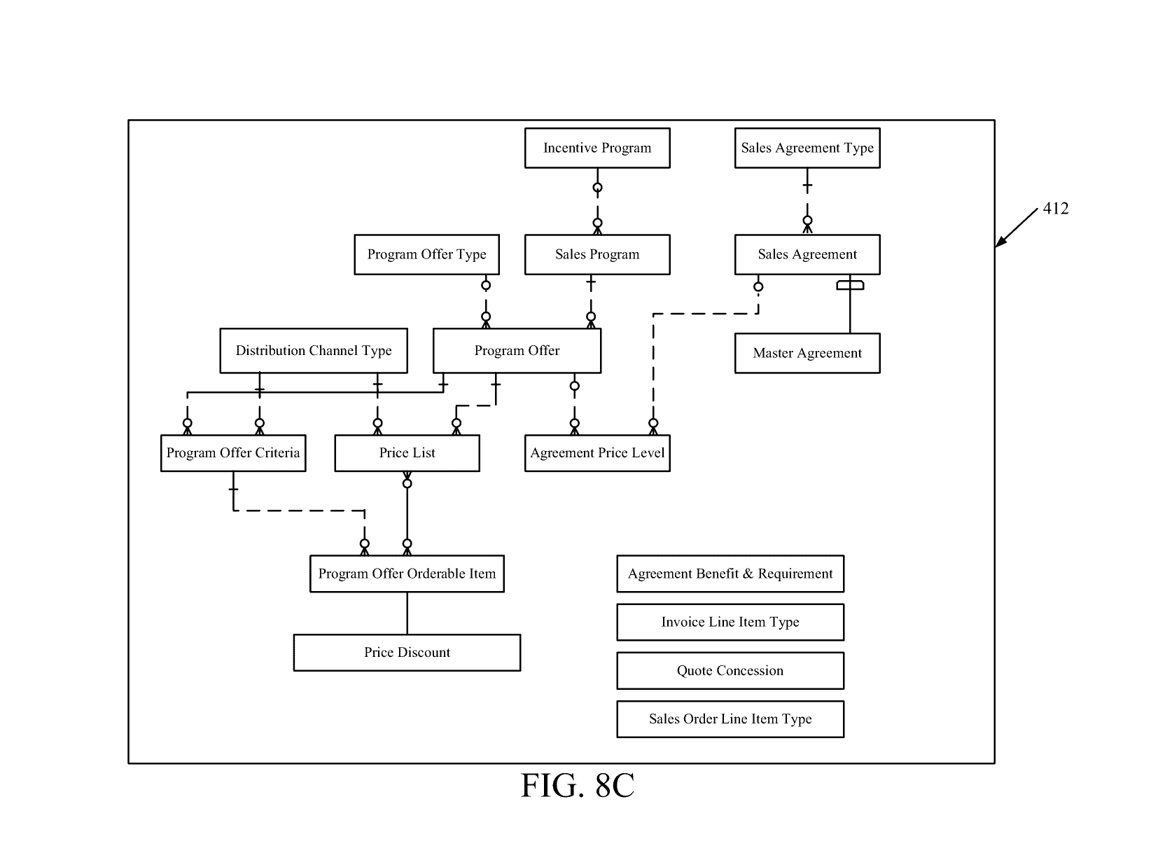

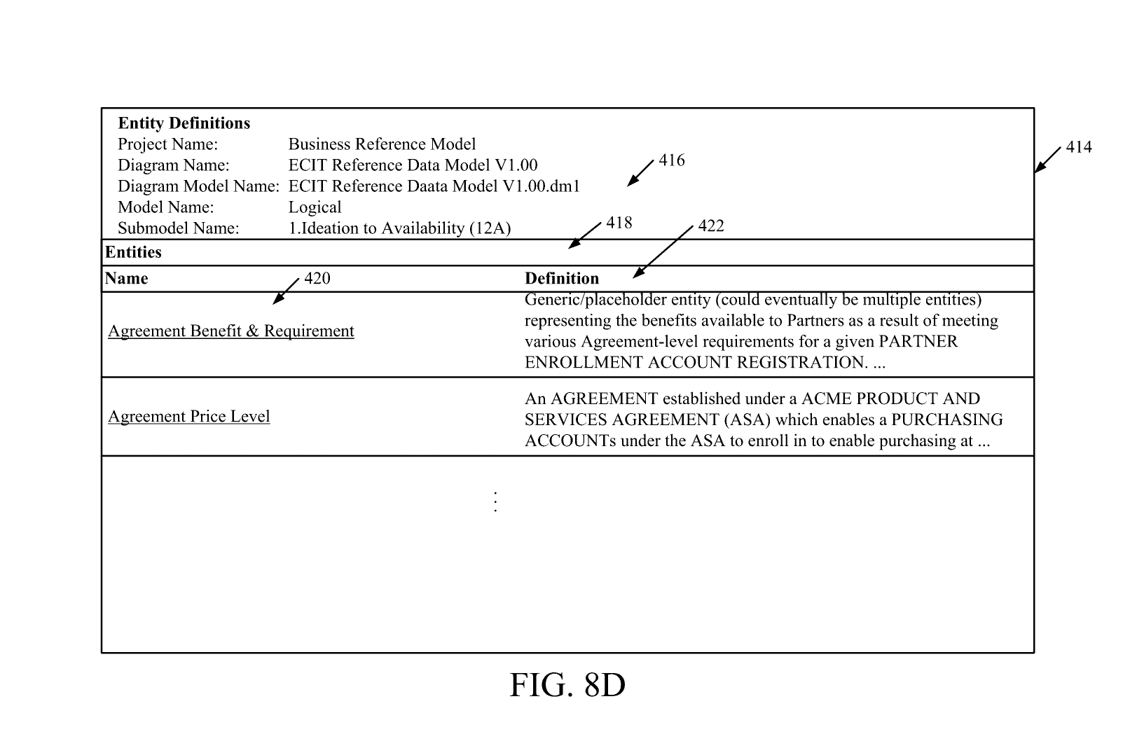

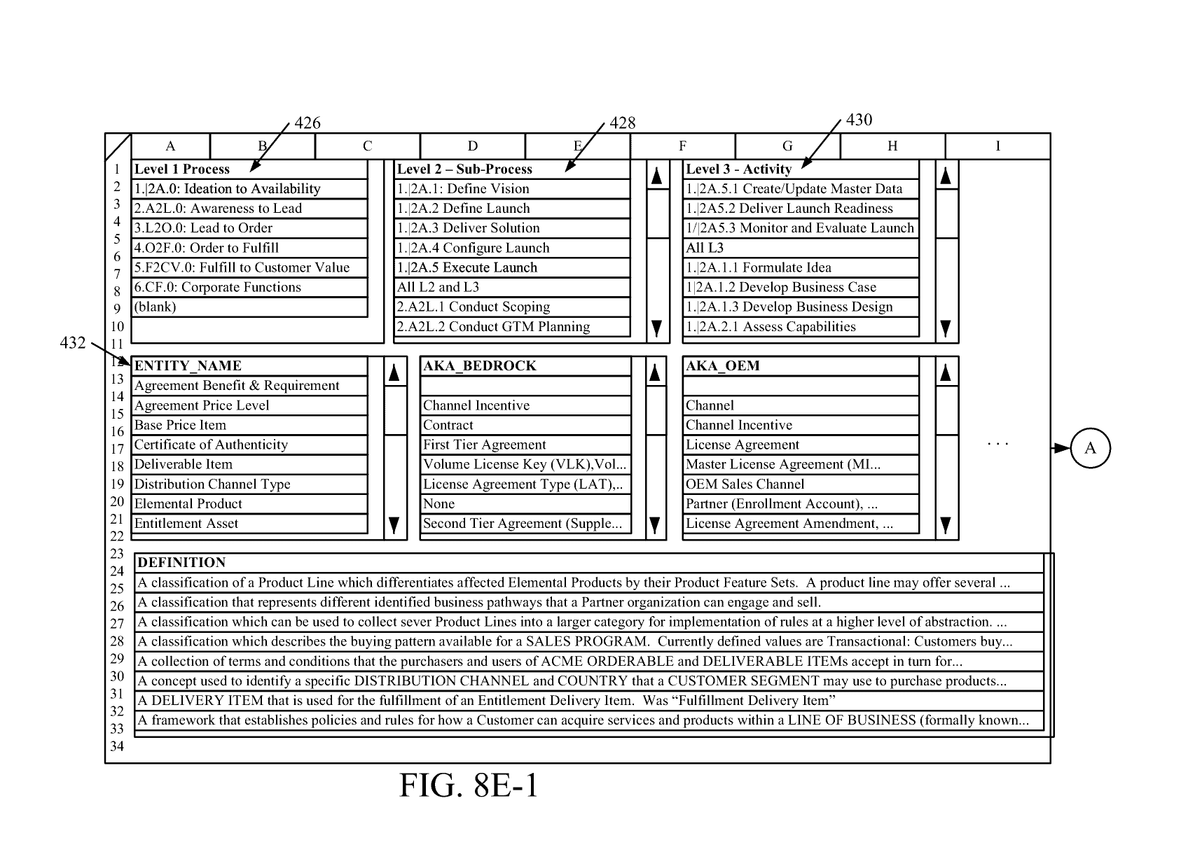

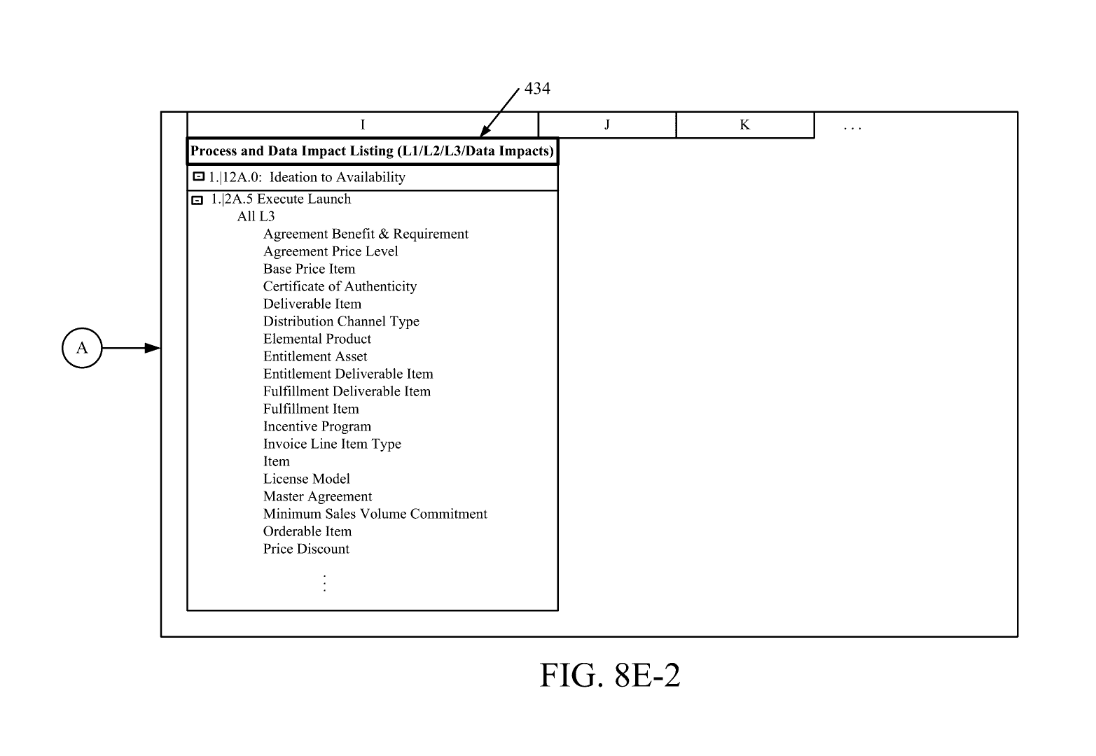

FIGS. 8A-1 and 8A-2 (collectively referred to as FIG. 8A) show one example of a user interface display that can be generated by model explorer 148. The user interface display 380 illustratively includes an end-to-end process display section 382 that displays a set of chevrons. Each chevron illustratively corresponds to a process that forms part of an end-to-end function performed by computing system 102. For instance, chevron 384 corresponds to an “ideation to availability” process. Chevron 386 corresponds to an “awareness to lead” process. Chevron 388 corresponds to a “lead to order” process. Chevrons 390, 392 and 394 correspond to “order to fulfill”, “fulfill to customer value” and “corporate functions” processes, respectively. Below each of the chevrons 384-394, the corresponding process is described in greater levels of granularity.

For instance, under chevron 384, the “ideation to availability” process has a set of five sub-processes. Each sub-process has a corresponding display element. The “define vision” sub-process corresponds to display element 396. The “define launch” sub-process corresponds to display element 398. The “deliver solution” sub-process corresponds to display element 400, the “configure launch” sub-processor corresponds to display element 402, and the “execute launch” sub-process corresponds to display element 403. Chevrons 384-394 and display elements 396-403 are also illustratively user actuable elements. For example, if the user actuates one of the elements 396-403, the user is navigated to a display showing the given subprocesses and all of the activities associated with that subprocess. Therefore, if the user actuates one of them, the user is navigated to a display showing that process or subprocess in more detail.

Each of the display elements 396-403, as well as each of the chevrons 384-394, has a data model link, a link to a corresponding taxonomy, and a link to one or more rules that cause the corresponding process or sub-process to be executed. For instance, the “ideation to availability” process represented by chevron 384 includes data model link 404, taxonomy link 406, rules link 408, and roles link 411. If the user actuates any of the links 404,406, 408 or 411, the user is illustratively navigated to another display that displays a portion of the interactive architecture reference model that 106 represents the data model, taxonomy, rules or roles that have been mapped to the “ideation to availability” process. Similarly, with each sub-process represented by display elements 396-403, the corresponding data model link will navigate the user to a data model that has been mapped to the sub-process. The taxonomy link navigates the user to a taxonomy that has been mapped to the sub-process. The rules link navigates the user to a set of rules that have been mapped to the sub-process, and the roles link 411 navigates the user to a set of roles that have been mapped to the sub-process. Thus, it can be seen from FIG. 8A that the user can actuate any of the user actuatable mechanisms (such as chevrons 384-394, the display elements 396-403 associated with each sub-process, the data model, taxonomy rules or roles mechanisms mapped to each process or sub-process) in order to navigate through the interactive architecture reference model 106 that represents the end-to-end function that is made up of the various processes displayed in FIG. 8A.

As mentioned above, the user can actuate some of the display mechanisms to drill down to view a more detailed view of a portion of the interactive architecture reference model 106. By way of example, the user can actuate chevron 384 to see more details corresponding to the “ideation to availability” process. FIG. 8B shows one example of a user interface display 404 that can be generated when the user does this. User interface display 404 shows some display elements that are similar to those shown in FIG. 8A, and they are similarly numbered. Thus, it can be seen in FIG. 8B that user interface display 404 includes display element 384 corresponding to the “ideation to availability” process, as well as display elements 396-403, that each correspond to one of the identified sub-processes. FIG. 8B also, however, displays a display element corresponding to each activity or task that makes up each of the identified sub-processes. For instance, FIG. 8B shows that the “define vision” sub-process represented by actuator 396 includes a first actuator 407 that represents the activity or task “formulate idea”. It includes another actuator 409 that represents the activity or task “develop business case”, and it includes yet another actuator 410 that represents the activity or task “develop business design”. If the user actuates any of the actuators 407, 409 or 410, the user is illustratively navigated to a display that shows the corresponding activity or task in even greater detail. For instance, there may be multiple layers of sub-tasks corresponding to each activity or task. Thus, each activity or task can be displayed at a greater level of granularity. The user can thus drill down, or drill up, to a view more detailed, or a less detailed representation, of the corresponding process.

Referring again to FIG. 8A, assume that the user now actuates data model actuator 404. This is a link that navigates the user to a visual representation of the data model that identifies the various data entities, and their level of participation, that support the “ideation to availability” process. FIG. 8C shows one example of a user interface display 412 that can be surfaced for the user, when the user does this. FIG. 8C shows only a portion of a data model, for the sake of example. It will be appreciated that more or different entities can be shown, and they can be shown in a variety of different ways.

It can be seen that each of the entities that supports the “ideation to availability” process can be represented in the data model display shown in user interface display 412. Each entity can be represented by one of the nodes in the display, while the level of participation can be represented by the connectors, or in other ways. Each of the nodes can also illustratively be a user actuatable input mechanism. When the user actuates one of the nodes, the user can be navigated to an even more detailed display showing details of the corresponding entity.

Referring again to FIG. 8A, the user can also actuate the taxonomy link 406 corresponding to “ideation to availability” chevron 384. In that case, the visualization system 152 illustratively navigates the user to a visualization of a corresponding taxonomy. FIG. 8D shows one example of a user interface display 414 that can be generated when the user does this. In the example shown in FIG. 4D, the user interface display 414 illustratively includes a definition section 416 that defines the particular project, model name, diagram and sub-model name (if any). It also includes a taxonomy display section 418 that displays a taxonomy for each of the entities in the data model (shown in FIG. 8C) that supports the “ideation to availability” process. The taxonomy can be helpful in a wide variety of different scenarios. For instance, the authors of some processes may define entities using certain words, while the authors of another process, that use the same entity, may define it using different words. The taxonomy illustratively normalizes the definitions of each entity so that it is the same across all processes, sub-processes, tasks and activities, etc. The taxonomy display section 418 illustratively includes a list of the entities (by name), shown generally at 420, and a definition of each of those entities, shown generally at 422.

The user can also provide inputs to model explorer 148, identifying a process, sub-process, activity, etc., that the user wishes to change. In response, model interaction component 300 illustratively accesses the various items in interactive architecture reference model 106 to identify the list of entities, and other items in the architecture of computing system 102, that will be affected by such a change. For instance, component 300 can interact with an API exposed by model 106, or it can interact with model 106 in other ways.

FIGS. 8E-1 and 8E-2 (collectively referred to as FIG. 8E) show one example of a user interface display 424 that can be generated when the user does this. It can be seen that a process selection user input mechanism 426, a sub-process selection user input mechanism 428, and an activity/task selection user input mechanism 430 are all provided by model explorer 148, and visualization system 152. The user has selected the “ideation to availability” process using selector 426. The user has also selected the “execute launch” sub-process using selector 428, and the user has selected all activities or tasks that make up the “execute launch” sub-process, using selector 430. The entities that support the selected process, sub-process and activities are listed at entity display portion 432. In addition, impact listing section 434 displays all of the processes and data elements that are impacted, in a hierarchical way.

This can be very helpful. For instance, if a user 114 wishes to make a change to the activities corresponding to the sub-process of “execute launch”, the user may simply export the process and data impact listing in section 434 so that it can be reviewed by a developer organization who may implement that change. The developer organization can then provide an estimate as to the resources needed to implement the change, and other items. This is because the impact listing in section 434 advantageously gives the development organization a quick reference as to the impact on the overall architecture of computing system 102 that the requested change will have. Other advantages can be derived as well.

The interactive architecture reference model 106 illustratively surfaces an impact listing that can be used by the manufacturer of computing system 102 to make changes. The manufacturer can quickly identify the areas that will be impacted, and it can thus identify resources needed to make the change. This improves the performance of the system itself. Instead of the user needing to perform multiple different searches, and view multiple different forms, entities, processes, etc., the information is surfaced directly from the interactive architecture reference model 106. This not only saves processing overhead (because the multiple different searches, navigation steps, etc. against system 102 are not needed), but it improves the efficiency of the user as well. The speed with which a user can understand the impact of a desired change on the architecture of computing system 102 is greatly increased.

It should also be noted that changes to a computing system can occur over time. This can happen, for instance, based on change requests that are fed into the system. The changes can be fed back to the system to ensure that later impact assessments are up-to-date. This can increase the relevance and accuracy of such assessments.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

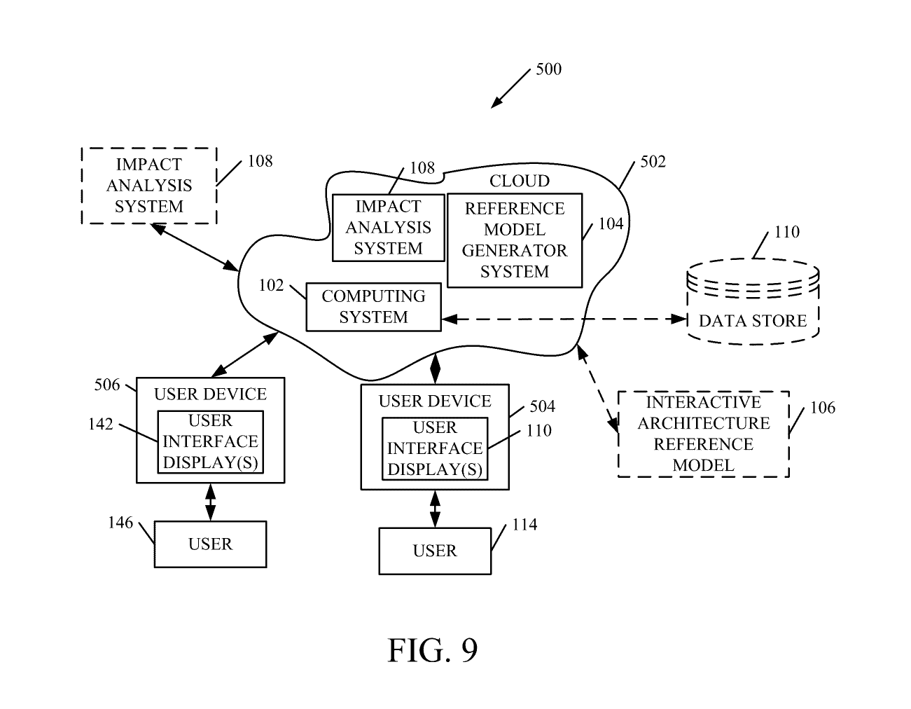

FIG. 9 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 9, some items are similar to those shown in FIG. 1 and they are similarly numbered. FIG. 9 specifically shows that systems 102, 104 and 108 can be located in cloud 502 (which can be public, private, or a combination where portions are public while others are private). Therefore, users 114, 116 and 146 use user devices 504 and 506 to access those systems through cloud 502.

FIG. 9 also depicts another example of a cloud architecture. FIG. 9 shows that it is also contemplated that some elements of architecture 102 can be disposed in cloud 502 while others are not. By way of example, data store 110 and model 106 can be disposed outside of cloud 502, and accessed through cloud 502. In another example, impact analysis system 108 can be outside of cloud 502. Regardless of where they are located, they can be accessed directly by devices 504 and 506, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

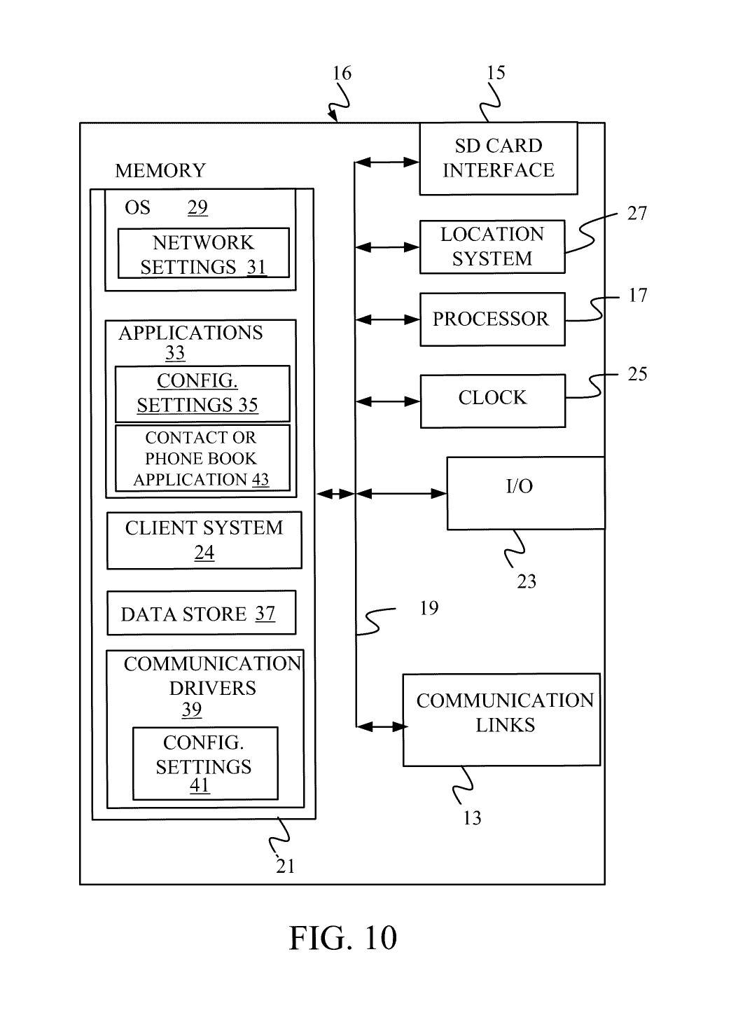

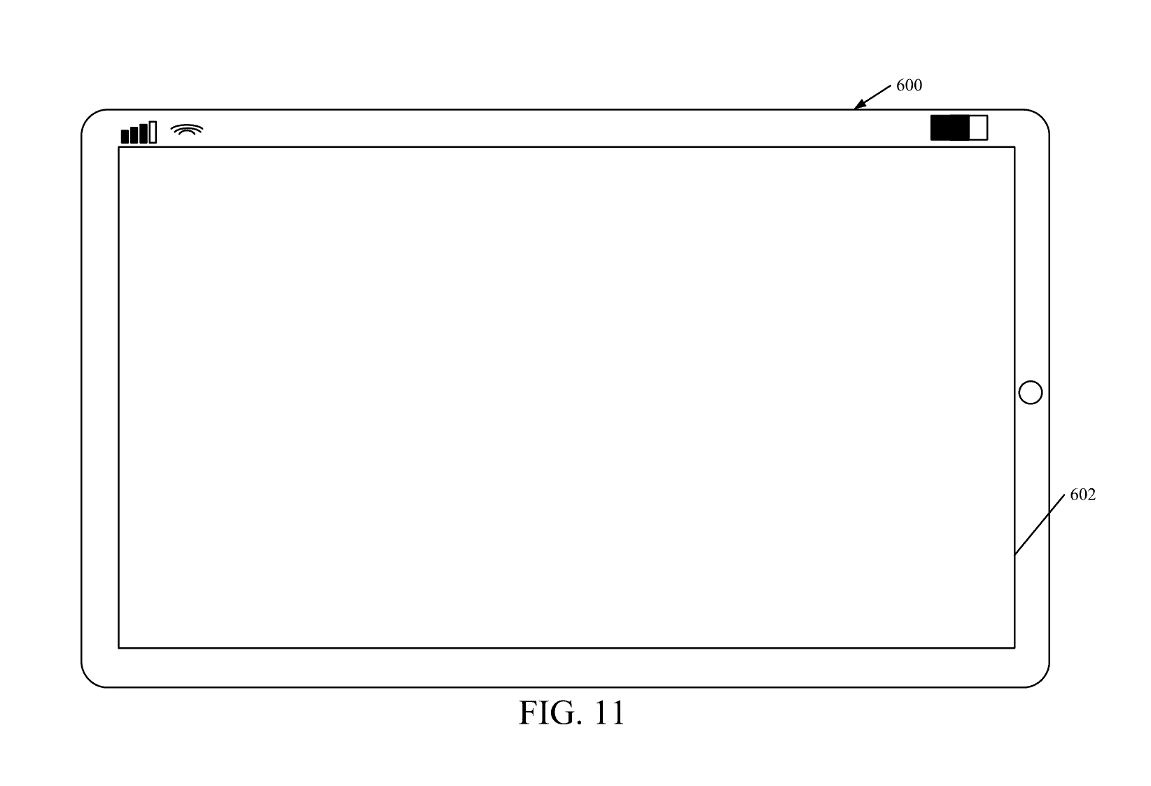

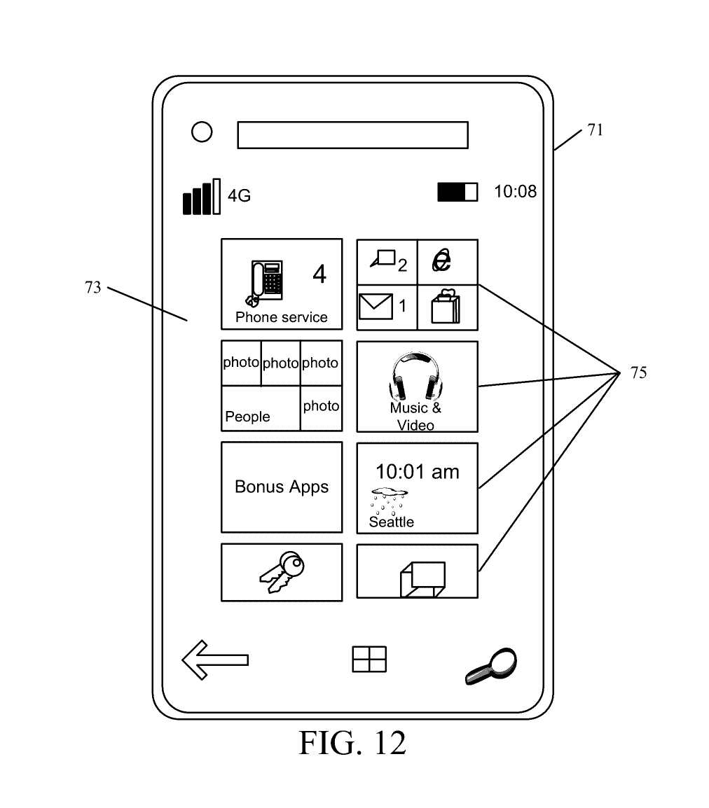

FIG. 10 is a simplified block diagram of one illustrative embodiment of a handheld or mobile computing device that can be used as a user's or client's hand held device 16, in which the present system (or parts of it) can be deployed. FIGS. 11-12 are examples of handheld or mobile devices.

FIG. 10 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers shown in previous Figures) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various business applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 11 shows one example in which device 16 is a tablet computer 600. In FIG. 11, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. Device 16 can be, a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples the phone also includes a Secure Digital (SD) card slot that accepts a SD card.

The mobile device can also be a personal digital assistant or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can also include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 12 shows that the phone can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

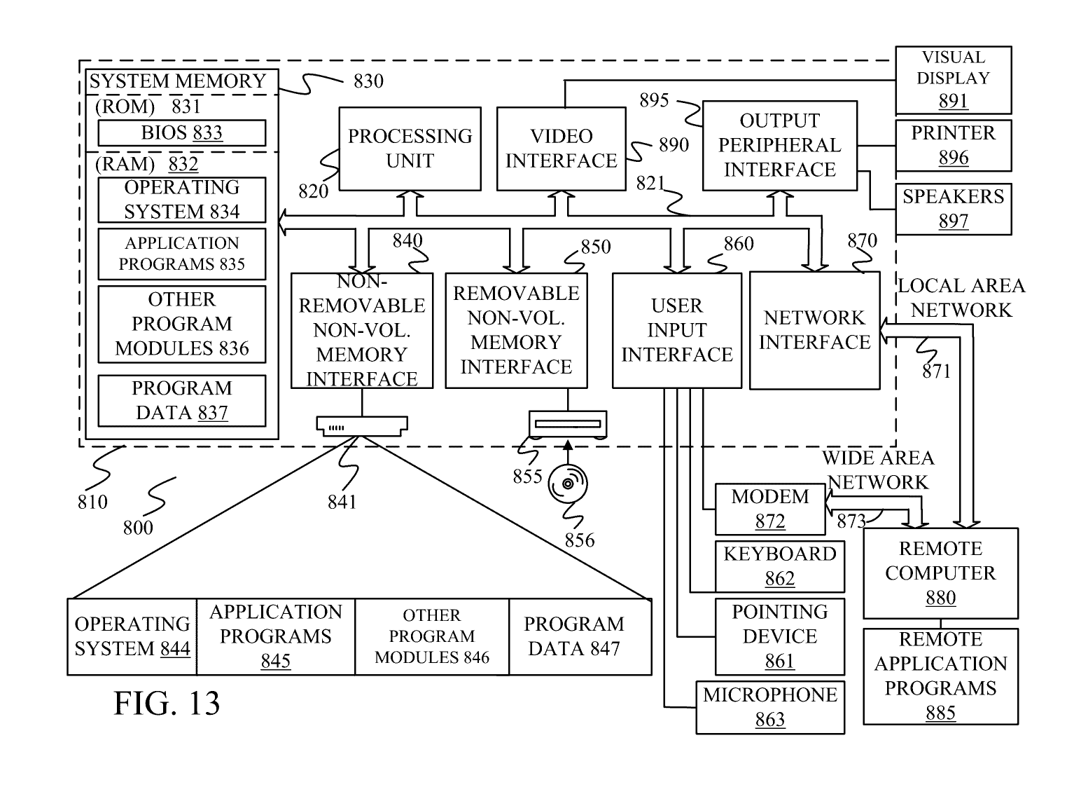

FIG. 13 is one example of a computing environment in which architecture 100, or parts of it, (for example) can be deployed. With reference to FIG. 13, a system for implementing some examples includes a general-purpose computing device in the form of a computer 810. Components of computer 810 may include, but are not limited to, a processing unit 820 (which can comprise processors or servers from previous Figures), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 13.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 13 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 810. In FIG. 13, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 13 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 13 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a process identifying system that identifies a set of processes in a given computing system;

a data-to-process mapping component that maps each given process in the identified set of processes to data elements that support the given process, with data-to-process mappings; and

a model generator and output component that generates an interactive architecture reference model for the identified set of processes and the data-to-process mappings, the interactive architecture reference model having an interface for interaction with the interactive architecture reference model.

Example 2 is the computing system of any or all previous examples and further comprising:

a visualization system; and

a model explorer that interacts with the interactive architecture reference model and controls the visualization system to surface a model representation user interface display indicative of the interactive architecture reference model, with user input mechanisms that are actuated to interact with the interactive architecture reference model.

Example 3 is the computing system of any or all previous examples wherein the model explorer comprises:

a model interaction component that receives a capability change request and interacts with the interactive architecture reference model to identify processes, in the set of processes, and corresponding data elements affected by the capability change request.

Example 4 is the computing system of any or all previous examples wherein the visualization system generates the model representation user interface display with navigation user input mechanisms and drill user input mechanisms, the model explorer navigating a user through the interactive architecture reference model in response to actuation of the navigation user input mechanism and generating the model representation user interface display with a different level of detail in response to actuation of the drill user input mechanism.

Example 5 is the computing system of any or all previous examples wherein the data elements comprise entities and wherein the data-to-process mapping component comprises:

an entity identifier component that identifies entities that support the given process and maps the entities to the given process in the data-to-process mappings.

Example 6 is the computing system of any or all previous examples wherein the data-to-process mapping component comprises:

an entity participation level identifier component that identifies a participation level of each of the identified entities in the given process.

Example 7 is the computing system of any or all previous examples wherein the data-to-process mapping component comprises:

a data model generator that generates a data model representing the identified entities and their corresponding levels of participation in the given process and maps the data model to the given process.

Example 8 is the computing system of any or all previous examples wherein the visualization system generates a data model link corresponding to the given process and wherein the model explorer navigates the user to the data model for the given process in response to detecting user actuation of the data model link.

Example 9 is the computing system of any or all previous examples wherein the process identifying system comprises:

a set of granular level identifier components that identify a set of increased granularity levels of each given process, the data-to-process mapping component mapping each given increased granularity level in each given process in the identified set of processes to data elements that support the given granularity level in the given process, with data-to-process mappings, and wherein the model generator and output component generates the interactive architecture reference model for the identified set of increased granularity levels and the data-to-process mappings.

Example 10 is the computing system of any or all previous examples wherein the set of increased granularity level identifier components comprises:

a sub-process identifier component that identifies sub-processes for each given process; and

an activity identifier component that identifies activities for each given process and sub-process.

Example 11 is the computing system of any or all previous examples wherein the process identifying system comprises:

a rule-to-process mapping component that identifies rules triggering each process, sub-process and activity and that generates a rule-to-process mapping based on the identified rules, the visualization system generating a set of rule links, one rule link corresponding to the given process and to each identified sub-process and activity, and wherein the model explorer navigates the user to the rule for the given process, sub-process and activity in response to detecting user actuation of the corresponding rule link.

Example 12 is the computing system of any or all previous examples wherein the process identifying system comprises:

a taxonomy component that identifies a taxonomy defining the entities that support each process, sub-process and activity and that generates a taxonomy mapping based on the identified taxonomies, the visualization system generating a set of taxonomy links, one taxonomy link corresponding to the given process and to each identified sub-process and activity, and wherein the model explorer navigates the user to the taxonomy for the given process, sub-process and activity in response to detecting user actuation of the corresponding taxonomy link.

Example 13 is a computer implemented method, comprising:

identifying a set of processes performed by a computing system;

mapping each given process in the identified set of processes to data elements that support the given process in the computing system, with data-to-process mappings;

generating an interactive architecture reference model for the identified set of processes and the data-to-process mappings, the interactive architecture reference model having an interface for interaction with the interactive architecture reference model; and

controlling a visualization system to surface a model representation user interface display indicative of the interactive architecture reference model, with user input mechanisms that are actuated to interact with the interactive architecture reference model through the interface.

Example 14 is the computer implemented method of any or all previous examples and further comprising:

receiving a capability change request;

interacting with the interactive architecture reference model to identify processes, in the set of processes, and corresponding data elements affected by the capability change request; and

controlling the visualization system to surface an interactive impact assessment indicative of the identified processes and corresponding data elements affected by the capability change request.

Example 15 is the computer implemented method of any or all previous examples wherein controlling the visualization system to surface the model representation user interface display comprises:

surfacing the model representation user interface display with navigation user input mechanisms and drill user input mechanisms;

detecting user interaction with the user input mechanisms;

navigating a user through the interactive architecture reference model in response to actuation of the navigation user input mechanism; and

surfacing the model representation user interface display with a different level of detail in response to actuation of the drill user input mechanism.

Example 16 is the computer implemented method of any or all previous examples wherein the data elements comprise entities and further comprising:

identifying entities that support the given process;

identifying a participation level of each of the identified entities in the given process; and

mapping the entities and the participation levels to the given process in the data-to-process mappings.

Example 17 is the computer implemented method of any or all previous examples wherein mapping the entities and participation levels comprises:

generating a data model representing the identified entities and their corresponding levels of participation in the given process; and

mapping the data model to the given process.

Example 18 is the computer implemented method of any or all previous examples and further comprising:

identifying a set of increased granularity levels of each given process;

mapping each given increased granularity level in each given process in the identified set of processes to data elements that support the given granularity level in the given process, with data-to-process mappings; and

generating the interactive architecture reference model for the identified set of increased granularity levels and the data-to-process mappings.

Example 19 is a computing system, comprising:

a visualization system;

a reference model generator system that identifies a set of processes in a given computing system, that maps each given process in the identified set of processes to data elements that support the given process, with data-to-process mappings, and that generates an interactive architecture reference model for the identified set of processes and the data-to-process mappings, the interactive architecture reference model having an interface for interaction with the interactive architecture reference model; and

an impact analysis system that receives a capability change request indicative of a requested capability change to the given computing system, accesses the interactive architecture reference model and controls the visualization system to surface an impact assessment result that identifies all data elements affected by the requested capability change.

Example 20 is the computing system of any or all previous examples wherein the reference model generator system comprises:

a process identifying system that identifies the set of processes and corresponding sub-processes and activities in the given computing system;

a data-to-process mapping component that maps each given process, sub-process and activity in the identified set of processes to data elements that support the given process, sub-process or activity with data-to-process mappings; and

a model explorer that interacts with the interactive architecture reference model and controls the visualization system to surface a model representation user interface display indicative of the interactive architecture reference model, with user input mechanisms that are actuated to interact with the interactive architecture reference model.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a process identifying system that identifies a set of processes in a given computing system;
a data-to-process mapping component that maps each given process in the identified set of processes to data elements that support the given process, with data-to-process mappings; and
a model generator and output component that generates an interactive architecture reference model for the identified set of processes and the data-to-process mappings, the interactive architecture reference model having an interface for interaction with the interactive architecture reference model.

2. The computing system of claim 1 and further comprising:
a visualization system; and
a model explorer that interacts with the interactive architecture reference model and controls the visualization system to surface a model representation user interface display indicative of the interactive architecture reference model, with user input mechanisms that are actuated to interact with the interactive architecture reference model.

3. The computing system of claim 2 wherein the model explorer comprises:
a model interaction component that receives a capability change request and interacts with the interactive architecture reference model to identify processes, in the set of processes, and corresponding data elements affected by the capability change request.

4. The computing system of claim 3 wherein the visualization system generates the model representation user interface display with navigation user input mechanisms and drill user input mechanisms, the model explorer navigating a user through the interactive architecture reference model in response to actuation of the navigation user input mechanism and generating the model representation user interface display with a different level of detail in response to actuation of the drill user input mechanism.

5. The computing system of claim 4 wherein the data elements comprise entities and wherein the data-to-process mapping component comprises:
an entity identifier component that identifies entities that support the given process and maps the entities to the given process in the data-to-process mappings.

6. The computing system of claim 5 wherein the data-to-process mapping component comprises:
an entity participation level identifier component that identifies a participation level of each of the identified entities in the given process.

7. The computing system of claim 6 wherein the data-to-process mapping component comprises:
a data model generator that generates a data model representing the identified entities and their corresponding levels of participation in the given process and maps the data model to the given process.

8. The computing system of claim 7 wherein the visualization system generates a data model link corresponding to the given process and wherein the model explorer navigates the user to the data model for the given process in response to detecting user actuation of the data model link.

9. The computing system of claim 8 wherein the process identifying system comprises:
a set of granular level identifier components that identify a set of increased granularity levels of each given process, the data-to-process mapping component mapping each given increased granularity level in each given process in the identified set of processes to data elements that support the given granularity level in the given process, with data-to-process mappings, and wherein the model generator and output component generates the interactive architecture reference model for the identified set of increased granularity levels and the data-to-process mappings.

10. The computing system of claim 9 wherein the set of increased granularity level identifier components comprises:
a sub-process identifier component that identifies sub-processes for each given process; and
an activity identifier component that identifies activities for each given process and sub-process.

11. The computing system of claim 10 wherein the process identifying system comprises:
a rule-to-process mapping component that identifies rules triggering each process, sub-process and activity and that generates a rule-to-process mapping based on the identified rules, the visualization system generating a set of rule links, one rule link corresponding to the given process and to each identified sub-process and activity, and wherein the model explorer navigates the user to the rule for the given process, sub-process and activity in response to detecting user actuation of the corresponding rule link.

12. The computing system of claim 10 wherein the process identifying system comprises:
a taxonomy component that identifies a taxonomy defining the entities that support each process, sub-process and activity and that generates a taxonomy mapping based on the identified taxonomies, the visualization system generating a set of taxonomy links, one taxonomy link corresponding to the given process and to each identified sub-process and activity, and wherein the model explorer navigates the user to the taxonomy for the given process, sub-process and activity in response to detecting user actuation of the corresponding taxonomy link.

13. The computing system of claim 11 wherein the process identifying system comprises:
a role-to-process mapping component that identifies roles corresponding to each process, sub-process and activity and that generates a role-to-process mapping based on the identified role, the visualization system generating a set of role links, one role link corresponding to the given process and to each identified sub-process and activity, and wherein the model explorer navigates the user to the role for the given process, sub-process and activity in response to detecting user actuation of the corresponding role link.

14. A computer implemented method, comprising:
identifying a set of processes performed by a computing system;
mapping each given process in the identified set of processes to data elements that support the given process in the computing system, with data-to-process mappings;
generating an interactive architecture reference model for the identified set of processes and the data-to-process mappings, the interactive architecture reference model having an interface for interaction with the interactive architecture reference model; and
controlling a visualization system to surface a model representation user interface display indicative of the interactive architecture reference model, with user input mechanisms that are actuated to interact with the interactive architecture reference model through the interface.

15. The computer implemented method of claim 14 and further comprising:
receiving a capability change request;
interacting with the interactive architecture reference model to identify processes, in the set of processes, and corresponding data elements affected by the capability change request; and
controlling the visualization system to surface an interactive impact assessment indicative of the identified processes and corresponding data elements affected by the capability change request.

16. The computer implemented method of claim 14 wherein controlling the visualization system to surface the model representation user interface display comprises:
surfacing the model representation user interface display with navigation user input mechanisms and drill user input mechanisms;
detecting user interaction with the user input mechanisms;
navigating a user through the interactive architecture reference model in response to actuation of the navigation user input mechanism; and
surfacing the model representation user interface display with a different level of detail in response to actuation of the drill user input mechanism.

17. The computer implemented method of claim 16 wherein the data elements comprise entities and further comprising:
identifying entities that support the given process;
identifying a participation level of each of the identified entities in the given process; and
mapping the entities and the participation levels to the given process in the data-to-process mappings.

18. The computer implemented method of claim 17 wherein mapping the entities and participation levels comprises:
generating a data model representing the identified entities and their corresponding levels of participation in the given process; and
mapping the data model to the given process and further comprising:
identifying a set of increased granularity levels of each given process;
mapping each given increased granularity level in each given process in the identified set of processes to data elements that support the given granularity level in the given process, with data-to-process mappings; and
generating the interactive architecture reference model for the identified set of increased granularity levels and the data-to-process mappings.

19. A computing system, comprising:
a visualization system;
a reference model generator system that identifies a set of processes in a given computing system, that maps each given process in the identified set of processes to data elements that support the given process, with data-to-process mappings, and that generates an interactive architecture reference model for the identified set of processes and the data-to-process mappings, the interactive architecture reference model having an interface for interaction with the interactive architecture reference model; and
an impact analysis system that receives a capability change request indicative of a requested capability change to the given computing system, accesses the interactive architecture reference model and controls the visualization system to surface an impact assessment result that identifies all data elements affected by the requested capability change.

20. The computing system of claim 19 wherein the reference model generator system comprises:
a process identifying system that identifies the set of processes and corresponding sub-processes and activities in the given computing system;
a data-to-process mapping component that maps each given process, sub-process and activity in the identified set of processes to data elements that support the given process, sub-process or activity with data-to-process mappings; and
a model explorer that interacts with the interactive architecture reference model and controls the visualization system to surface a model representation user interface display indicative of the interactive architecture reference model, with user input mechanisms that are actuated to interact with the interactive architecture reference model.
